(19) United States
(12) Patent Application Publication
(10) Pub. No.: US 2013/0215000 A1
(43) Pub. Date: Aug. 22, 2013

(54) PHASE DELAY TO AVOID BLADE TIP COLLISION IN ROTATING BLADES SIGNAGE

(71) Applicants: Mark Joseph Dyer, San Jose, CA (US); Marc Maurice Mignard, San Jose, CA (US)

(72) Inventors: Mark Joseph Dyer, San Jose, CA (US); Marc Maurice Mignard, San Jose, CA (US)

(73) Assignee: QUALCOMM MEMS TECHNOLOGIES, INC., San Diego, CA (US)

(21) Appl. No.: 13/398,688

(22) Filed: Feb. 16, 2012

(51) Int. Cl. G09G 3/20; F21S 4/00; F21S 10/00; F21V 21/26

(52) U.S. Cl. 345/31; 362/430; 362/249.1; 362/249.03

(57) ABSTRACT

Some implementations include an array of devices having blades configured for rotation. The devices may be lighting devices having a plurality of pixel elements disposed on each blade. The blades of these devices may sweep out an area that overlaps with an area swept out by the blades of an adjacent device in a row. Each device in a column may have blades that are configured to rotate in an opposite direction from the blades of an adjacent device in the column. Diagonally adjacent devices (offset by one row and one column) may have blades that rotate in the same direction but out of phase. The blades of diagonally adjacent devices may or may not sweep out overlapping areas. The areas may overlap by more or less than a width of a pixel element.

### TECHNICAL FIELD

This disclosure relates to display devices, including but not limited to persistence-of-vision display devices.

### DESCRIPTION OF THE RELATED TECHNOLOGY

“Persistence of vision” is a term that is associated with motion perception in human beings. For example, persistence-of-vision theories are often invoked to explain why a series of still images can be perceived as animation. Persistence of vision is sometimes attributed to properties of the eye and particularly to a process by which an afterimage is thought to persist on the retina. However, some theorists believe that human motion perception may be better explained by optical illusions known as the phi phenomenon and/or beta movement.

Regardless of which underlying theory is more precise, there are numerous display devices that are commonly referred to as persistence-of-vision display devices. A persistence-of-vision display device may include apparatus for rapidly moving optical elements along a linear or circular path. Persistence-of-vision display devices may be used to provide a large-format display, for example, for signage. Such devices may include multiple lighting devices having rotating blades with attached pixel elements.

Providing persistence-of-vision display devices, including but not limited to signage devices, can involve various challenges. If the blades do not rotate in the same plane, there may be only a small range of acceptable viewing angles due to parallax issues. If the blades do rotate in the same plane, the area swept out by the blades of adjacent lighting devices should overlap to some degree. It can be difficult to avoid blade collisions because the blade tips pass very close to one another.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus which includes an array of devices having blades configured for rotation. The devices may be lighting devices having a plurality of pixel elements disposed on each blade. Diagonally adjacent devices (offset by one row and one column) may have blades that rotate in the same direction but out of phase. The blades of diagonally adjacent devices may sweep out overlapping areas. In some such implementations, the areas may overlap by at least a width of a pixel element, whereas in other implementations the areas may overlap by a width of a pixel element or less. In other implementations, the blades of diagonally adjacent devices may not sweep out overlapping areas.

Another innovative aspect of the subject matter described in this disclosure can be implemented in an apparatus that includes an array of devices having blades configured for rotation. The apparatus may include at least two rows of the devices; and at least two columns of the devices. The blades of diagonally adjacent devices offset by one row and one column may be configured to rotate in the same direction and in substantially the same plane, to sweep out diagonal overlap areas, and to rotate out of phase. In some implementations, each of the devices includes four blades. In alternative implementations, the devices may have more or fewer blades.

The blades of a first device in each row may be configured to rotate in a first direction and sweep out a first area and the blades of an adjacent second device in the row may be configured to rotate in a second direction opposite the first direction and sweep out a second area in substantially the same plane that overlaps the first area. The blades of the first device and the blades of the second device may be out of phase by approximately 40 degrees to 50 degrees. The first area may overlap with the second area by more than half of a blade radius. The blades of a first device in a row and the blades of a third device in a row may rotate in phase and in the same direction. A first axis of rotation of a first device in a row may be offset by a second axis of rotation of a second device in the row by less than 1.5 times a radius of a blade.

The blades of a first device in each column may be configured to rotate in a first direction and sweep out a first area and the blades of an adjacent second device in the column may be configured to rotate in a second direction opposite the first direction and sweep out a second area in substantially the same plane that overlaps the first area. The blades of the first device and the blades of the second device may be out of phase by approximately 40 degrees to 50 degrees. The first area may overlap with the second area by more than half of a blade radius. A first axis of rotation of a first device in a column may be offset by a second axis of rotation of a second device in the column by less than 1.5 times a radius of a blade.

In some implementations, the blades of diagonally adjacent devices may rotate out of phase by an angle in the range of approximately plus or minus 25 degrees. According to some such implementations, the blades of diagonally adjacent devices may rotate out of phase by between 10 degrees and 20 degrees.

The apparatus may include a rotation control system configured for rotating the blades. The apparatus may include a plurality of pixel elements disposed on each blade. The pixel elements may include light-emitting diodes. In some implementations, the diagonal overlap areas may have a width that is at least as large as a width of a pixel element. However, in other implementations the diagonal overlap areas may have a width that is less than or equal to a width of a pixel element.

The apparatus may include a pixel element control system configured for controlling the pixel elements. The pixel element control system may be configured to control the pixel elements to produce an image of a display. In some implementations, the display may be a persistence-of-vision display. The image may be a still image or a video image.

Another innovative aspect of the subject matter described in this disclosure can be implemented in an apparatus that includes an array of devices having blades configured for rotation. The apparatus may include at least two rows of the devices and at least two columns of the devices. The apparatus may be configured for rotating the blades of diagonally adjacent devices, offset by one row and one column, in the same direction to sweep out diagonal overlap areas in substantially the same plane without causing a blade collision. In some implementations each of the devices includes four blades, whereas in other implementations at least some of the devices may include more or fewer blades.

The apparatus may be configured for rotating the blades of diagonally adjacent devices out of phase. The apparatus may be configured for rotating the blades of diagonally adjacent devices out of phase by an angle in the range of approximately plus or minus 25 degrees. In some implementations, the apparatus may be configured for rotating the blades of diagonally adjacent devices out of phase by between 10 degrees and 20 degrees.

The apparatus may be configured for rotating the blades of a first device in the row in a first direction to sweep out a first area and for rotating the blades of an adjacent second device in the row in a second direction opposite the first direction to sweep out a second area that overlaps the first area and is in substantially the same plane as the first area. The apparatus may be configured for rotating the blades of the first device out of phase with the blades of the second device by approximately 40 degrees to 50 degrees. The first area may overlap with the second area by more than half of a blade radius.

The apparatus may be configured for rotating the blades of a first device in the column in a first direction to sweep out a first area and for rotating the blades of an adjacent second device in the column in a second direction opposite the third direction to sweep out a second area that overlaps the first area and is in substantially the same plane as the first area. The apparatus may be configured for rotating the blades of the first device out of phase with the blades of the second device by approximately 40 degrees to 50 degrees. The first area may overlap with the second area by more than half of a blade radius.

Another innovative aspect of the subject matter described in this disclosure can be implemented in a method of operating rows and columns of devices having blades configured for rotation. The method may involve rotating the blades of diagonally adjacent devices, offset by one row and one column, in the same direction and causing the blades of the diagonally adjacent devices to sweep out diagonal overlap areas in substantially the same plane without causing a blade collision.

The method may involve rotating the blades of diagonally adjacent devices out of phase. The method may involve rotating the blades of diagonally adjacent devices out of phase by an angle in the range of approximately plus or minus 25 degrees. For example, the method may involve rotating the blades of diagonally adjacent devices out of phase by between 10 degrees and 20 degrees.

The method may involve determining whether a blade collision threshold has been reached. The method may involve taking corrective action if it is determined that a blade collision threshold has been reached. The corrective action may involve bringing a phase difference angle of the diagonally adjacent devices within a range of acceptable phase difference angles.

Another innovative aspect of the subject matter described in this disclosure can be implemented in an apparatus that includes an array of devices having blades configured for rotation. The array may include at least two rows and two columns of the devices. Each device may include a plurality of pixel elements disposed on each blade with a pitch P. Each blade may have at least one edge pixel element disposed at a maximum distance from an axis of rotation of the blade. The apparatus may include a rotation control system configured to rotate the blades of diagonally adjacent devices offset by one row and one column in the same direction and in substantially the same plane and to produce a spacing S between edge subpixels disposed on the blades of diagonally adjacent devices when the diagonally adjacent blades are aligned. In some implementations, S may be less than or substantially equal to P. In other implementations, S may be greater than P.

The blades of diagonally adjacent devices may or may not sweep out diagonal overlap areas, depending on the implementation. In some implementations, each of the devices may include four blades, whereas in other implementations at least some devices may include more or fewer blades. The apparatus may include a pixel element control system configured for controlling the pixel elements to produce an image of a persistence-of-vision display.

Details of one or more implementations of the subject matter described in this specification are set forth in the accompanying drawings and the description below. Other features, aspects, and potential advantages will become apparent from the description, the drawings, and the claims. Note that the relative dimensions of the following figures may not be drawn to scale.

### BRIEF DESCRIPTION OF THE DRAWINGS

FIG. 1 shows an example of a persistence-of-vision signage apparatus having an array of devices with blades configured for rotation.

FIG. 2A provides an example of how the blades of diagonally adjacent lighting devices may be controlled to sweep out overlapping areas while still avoiding blade collisions.

FIG. 2B provides an example of a diagonal overlap area that is approximately twice the width of a pixel element.

FIG. 2C provides an example of how the blades of diagonally adjacent lighting devices may be controlled to sweep out an area that does not overlap, but yet does not produce a hole in a persistence-of-vision display.

FIG. 3 shows an example of a block diagram indicating components of a persistence-of-vision signage apparatus.

FIG. 4 shows an example of a flow diagram that outlines a process of operating a persistence-of-vision signage apparatus.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in various devices or systems. Thus, the teachings are not intended to be limited to the implementations depicted solely in the Figures, but instead have wide applicability as will be readily apparent to one having ordinary skill in the art.

Some implementations described herein include an array of devices having blades configured for rotation. The devices may be lighting devices having a plurality of pixel elements disposed on each blade. The array may include rows of devices having blades configured to rotate in an opposite direction from adjacent blades in a row. The blades of these devices may sweep out an area that overlaps with an area swept out by the blades of an adjacent device in the row. Some implementations may include columns of devices, wherein each device in a column has blades that are configured to rotate in an opposite direction from the blades of an adjacent device in the column. The blades of each device in the column may sweep out an area that overlaps an area swept out by the blades of an adjacent device in the column. Diagonally adjacent devices (offset by one row and one column) may have blades that rotate in the same direction but out of phase. The blades of diagonally adjacent devices may sweep out overlapping areas. The areas may overlap by at least a width of a pixel element.

Particular implementations of the subject matter described in this disclosure can be implemented to realize one or more of the following potential advantages. For example, rotating the blades in substantially the same plane allows for a relatively larger range of acceptable viewing angles than implementations wherein the blades do not rotate in the same plane. Ensuring that the area swept out by the blades of one lighting device overlap by at least one pixel element with the area swept out by the blades of an adjacent lighting device can prevent holes in the image(s) produced by the display. Some implementations described herein allow the blade tips of adjacent devices, including but not limited to diagonally adjacent devices, to pass very close to one another while avoiding blade collisions.

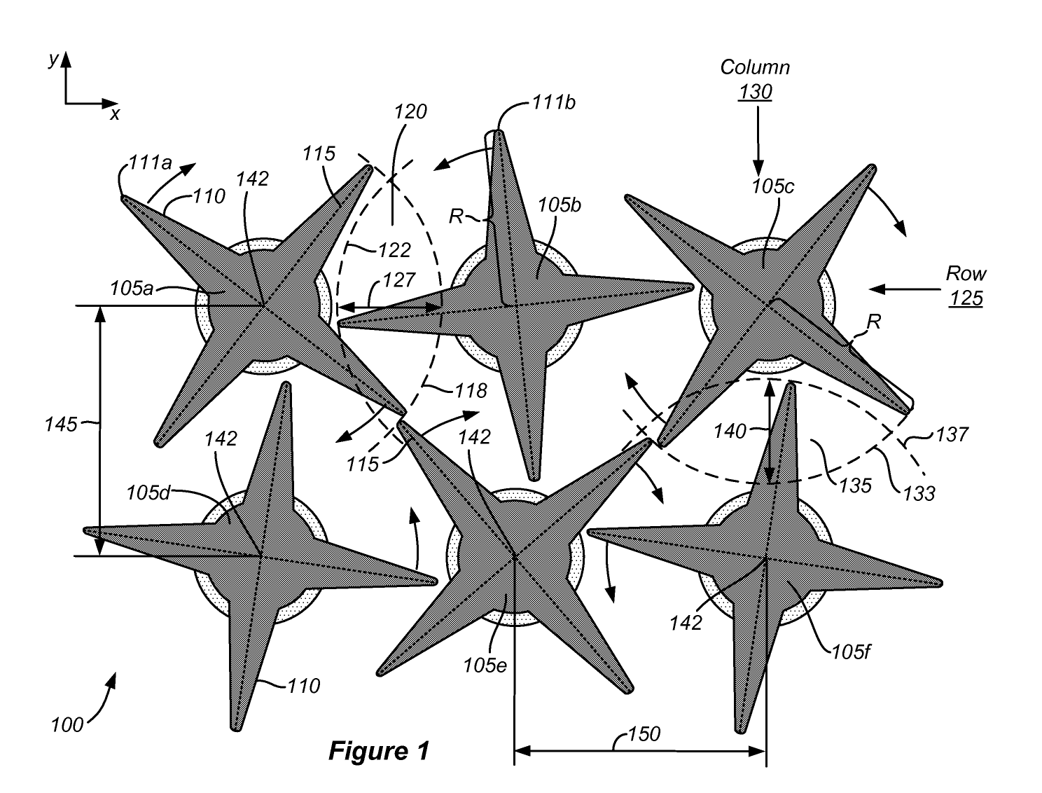

FIG. 1 shows an example of a persistence-of-vision signage apparatus having an array of devices with blades configured for rotation. In this example, the persistence-of-vision signage apparatus 100 includes lighting devices 105a-105f, formed into two rows and three columns. Alternative implementations may have more or fewer of the lighting devices 105, different numbers of blades 110 on the lighting devices 105, etc. Moreover, the lighting devices 105 may or may not be formed into rows and/or columns.

In this example, each of the lighting devices 105 includes four blades 110, with pixel elements 115 disposed on each of the blades 110. In alternative implementations, at least some of the lighting devices 105 may include more or fewer of the blades 110. In some implementations, the lighting devices 105 may include more than four blades 110. In some implementations, the pixel elements 115 may be light-emitting diodes (LEDs), incandescent lamps or another suitable light source. Here, the pixel elements 115 have a substantially uniform spacing along the radius R of the blades 110. However, the arrangement of the pixel elements 115 shown in FIG. 1 is merely an example. In alternative implementations, the pixel elements 115 may or may have not have a substantially uniform spacing and may be disposed in locations other than along the radius R of the blades 110.

In this implementation, the blades 110 of every lighting device 105 rotate in substantially the same plane. The blades of every other lighting device 105 in a row or column rotate in phase and in the same direction. For example, the blades of a first lighting device 105 in a row (e.g., the lighting device 105a) and the blades of a third lighting device 105 in the row (e.g., the lighting device 105c) rotate in phase and in the same direction.

Here, the blades 110 of the lighting device 105a rotate in the opposite direction from the blades 110 of the adjacent lighting device 105b in the row 125. In this example, the blades 110 of the lighting device 105a rotate in a clockwise direction and the blades 110 of the lighting device 105b rotate in a counterclockwise direction. Therefore, the blades 110 of lighting device 105a are moving downward when the blades 110 pass near the lighting device 105b and the blades 110 of lighting device 105b are moving downward when the blades 110 pass near the lighting device 105a.

However, the blades 110 of lighting device 105a and the blades 110 of lighting device 105b rotate out of phase from one another. For example, the projection of the tip 111a of the blade of device 105a onto the x-axis may be represented by R sin(ωt+θᵢ), while the projection of the tip 111b of a corresponding blade of device 105b onto the x-axis may be represented by R sin(−ωt+θ₂), where the absolute value of (θ₁−θ₂) represents the phase difference between the blades of the two lighting devices. In some implementations, the blades 110 of lighting device 105a are out of phase with respect to the blades 110 of lighting device 105b by an angle that is in the range of approximately 40 degrees to 50 degrees. Accordingly, in such implementations there can be substantial overlap between the areas swept out by the blades 110 of lighting devices 105a and 105b without causing blade collision.

On example of such overlap is shown in FIG. 1. The arc 118 is a portion of the circumference of an area swept out by the blades 110 of the lighting device 105a, whereas the arc 122 is a portion of the circumference of an area swept out by the blades 110 of the lighting device 105b. The intersection of the arc 118 and the arc 122 define an overlap area 120 having a maximum width 127. In this example, the maximum width 127 of the overlap area 120 is more than half of the radius R of the blades 110. In some implementations, the maximum width 127 of the overlap area 120 is approximately (2−(2)^{1/2})R or approximately 0.59 R.

Similarly, the blades 110 of the lighting device 105c rotate in the opposite direction from the blades 110 of the adjacent lighting device 105f in the column 130. Therefore, in one example, the blades 110 of the lighting device 105c are moving to the left when the blades 110 pass near the lighting device 105f, and the blades 110 of the lighting device 105f are moving to the left when the blades 110 pass near the lighting device 105c. However, the blades 110 of lighting device 105c and the blades 110 of lighting device 105f rotate out of phase from one another. In some implementations, the blades 110 of lighting device 105c are out of phase with respect to the blades 110 of lighting device 105f by an angle that is in the range of approximately 40 degrees to 50 degrees.

In the example shown in FIG. 1, the arc 133 is a portion of the circumference of an area swept out by the blades 110 of the lighting device 105c, whereas the arc 137 is a portion of the circumference of an area swept out by the blades 110 of the lighting device 105f. The intersection of the arc 133 and the arc 137 define an overlap area 135 having a maximum width 140. In this example, the maximum width 140 is more than half of the radius R of the blades 110.

In this implementation, the rows 125 and the columns 130 all have a substantially uniform spacing. The axis of rotation 142 of each lighting device 105 in a column is offset from the axis of rotation 142 of a neighboring lighting device 105 in the column by substantially the same column offset distance 145. Similarly, the axis of rotation 142 of each lighting device 105 in a row is offset from the axis of rotation 142 of a neighboring lighting device 105 in the row by substantially the same row offset distance 150. In this example, the column offset distance 145 and the row offset distance 150 are both less than 1.5 times the radius R of the blades 110.

In this example, diagonally adjacent lighting devices 105 (offset by one row and one column) have blades 110 that rotate in the same direction. The lighting device 105a and the lighting device 105e, for example, are diagonally adjacent. Here, the blades 110 of the lighting devices 105a and 105e both rotate clockwise. It is relatively more challenging to have the blades 110 of diagonally adjacent lighting devices 105 sweep out overlapping areas in substantially the same plane and yet still avoid blade collisions. However, in order to avoid having a hole in the images displayed by the persistence-of-vision signage apparatus 100, in some implementations, these areas overlap by at least the width of a pixel element.

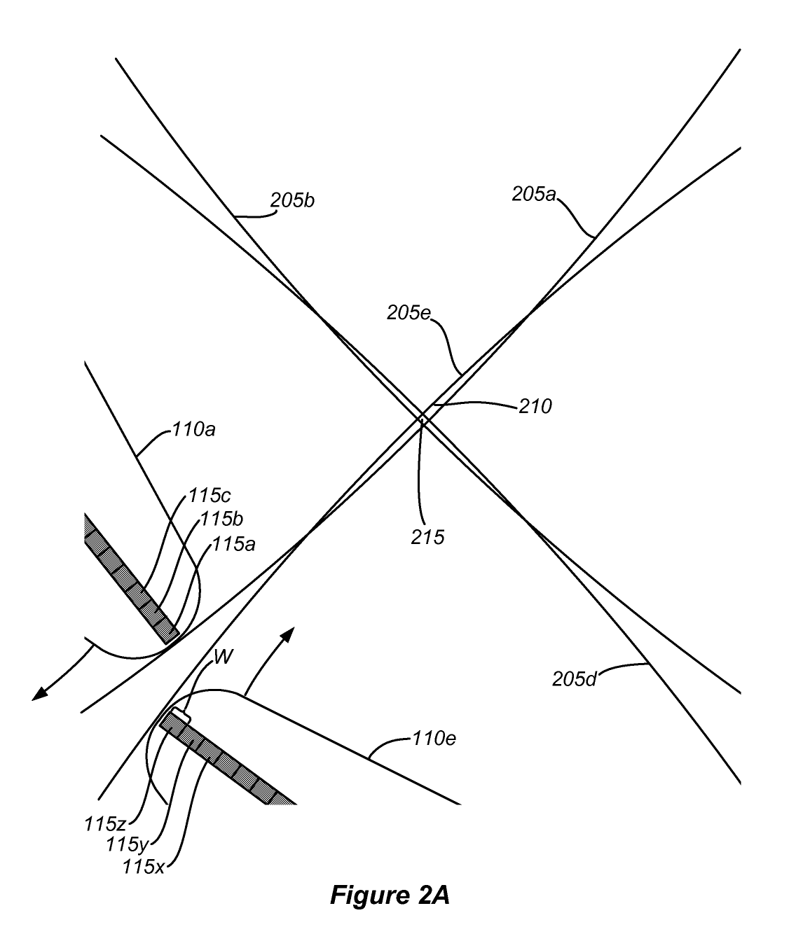

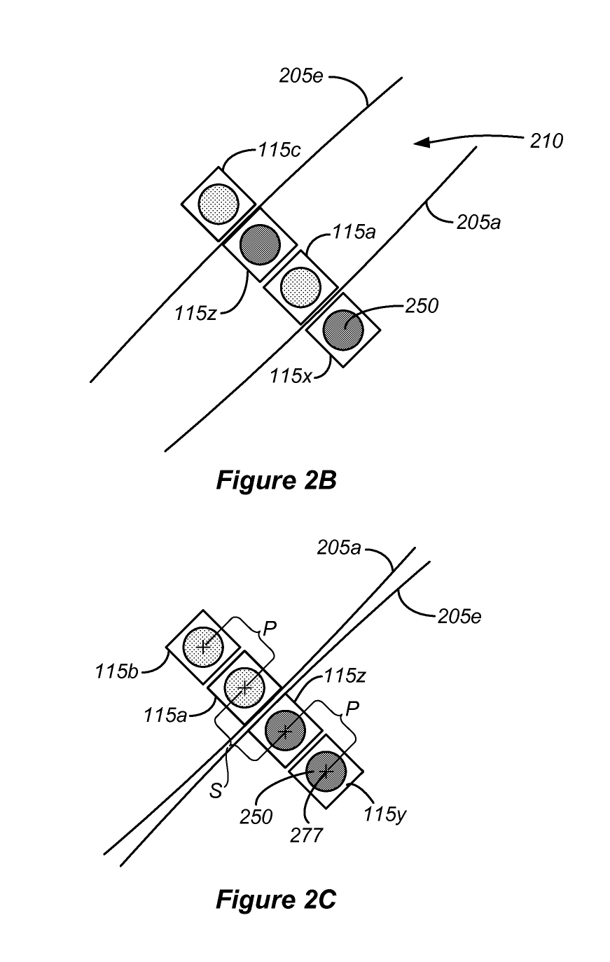

FIG. 2A provides an example of how the blades of diagonally adjacent lighting devices may be controlled to sweep out overlapping areas while still avoiding blade collisions. As noted above, the lighting device 105a and the lighting device 105e are diagonally adjacent. In this example, the blade 110a of the lighting device 105a and the blade 110e of the lighting device 105e are diagonally adjacent and are both rotating clockwise. The blade 110a sweeps out an area defined by the arc 205a, whereas the blade 110e sweeps out an area defined by the arc 205e. Here, the diagonal overlap area 210 has a maximum width that is equal to or less than the width W of an individual pixel element 115. In this example, the diagonal overlap area 210 has a maximum width that is equal to or less than the width W of the pixel element 115a, which is mounted on the blade 110a, and equal to or less than the width W of the pixel element 115z, which is mounted on the blade 110e. Because pixel elements 115a and 115z are disposed on the outer edge of the blades 110a and 110e, respectfully, at a maximum distance from an axis of rotation of each blade, these pixel elements are sometimes referred to herein as “edge pixel elements.”

At the moment depicted in FIG. 2A, the paddle 110a has just moved out of the overlap area 210. Because of a slight phase shift between the rotations of the blades 110a and 110e, the blade 110e is just about to enter the diagonal overlap area 210 after paddle 110a has moved out of the overlap area 210. Accordingly, the blade 110a does not collide with the blade 110e. In some implementations, the blades 110 of diagonally adjacent lighting devices 105 rotate out of phase by an angle in the range of approximately 10 degrees and 20 degrees. In other implementations, the blades 110 of diagonally adjacent lighting devices 105 rotate out of phase by an angle in the range of approximately plus or minus 25 degrees, in a total range of approximately 50 degrees.

The blades 110 of lighting device 105b (see FIG. 1) sweep out an area defined by the arc 205b and the blades 110 of lighting device 105d sweep out an area defined by the arc 205d. In this example, the areas defined by the arcs 205a, 205b, 205d and 205e all overlap in the area 215. Here, the area 215 is smaller than the area of an individual pixel element 115. In some implementations, the area 215 may be substantially equal to the area of an individual pixel element 115.

However, in alternative implementations, the diagonal overlap area 210 may have a maximum width that is greater than the width W of an individual pixel element 115. Accordingly, the area 215 of such implementations may also be greater than the width W of an individual pixel element 115. One such example is shown in FIG. 2B.

FIG. 2B provides an example of a diagonal overlap area that is approximately twice the width of a pixel element. In this example, the pixel elements 115 correspond to those shown on the blades 110a and 110e of FIG. 2A. In this example, the pixel elements 115 are LEDs having an opening 250 from which light is emitted. The blade 110a sweeps out an area defined by the arc 205a, whereas the blade 110e sweeps out an area defined by the arc 205e. However, the pixel elements 115 mounted on the blades 110a and 110e would not be in the positions shown in FIG. 2B at the same time if the blades 110a and 110e are rotating in the same plane. In the example shown in FIG. 2B, the diagonal overlap area 210 has a maximum width that is greater than the widths of the pixel elements 115a and 115b, the latter of which is obscured by the image of the pixel element 115z. Similarly, the diagonal overlap area 210 has a maximum width that is greater than the widths of the pixel elements 115y and 115z, the former of which is obscured by the image of the pixel element 115a.

FIG. 2C provides an example of how the blades of diagonally adjacent lighting devices may be controlled to sweep out an area that does not overlap, but yet does not produce a hole in a persistence-of-vision display. The blade 110a sweeps out an area defined by the arc 205a, which does not overlap with an area defined by the arc 205e that is swept out by the blade 110e. Therefore, if the blades 110a and 110e were rotating in the same plane, the blade 110a would not collide with the blade 110e even if there were no phase difference between the motions of the blades 110a and 110e. The pixel elements 115 mounted on the blades 110a and 110e may or may not be in the positions shown in FIG. 2C at the same time, depending on the particular implementation details.

Nonetheless, the nearest position of the edge pixel element 115a is sufficiently close to the nearest position of the edge pixel element 115z (shown in FIG. 2C) that no hole would be produced in a corresponding persistence-of-vision display. In this example, the pixel elements 115 are disposed on each of the blades 110a and 110e with a pitch P that is approximately equal to a spacing S at the nearest position of the edge pixel elements 115a and 115z. In this example, both P and S are measured from a center 277 of each opening 250. In alternative implementations, the spacing S may be less than P or slightly greater than P. However, if the spacing S is substantially greater than P, there is a risk of producing an observable hole in the corresponding persistence-of-vision display.

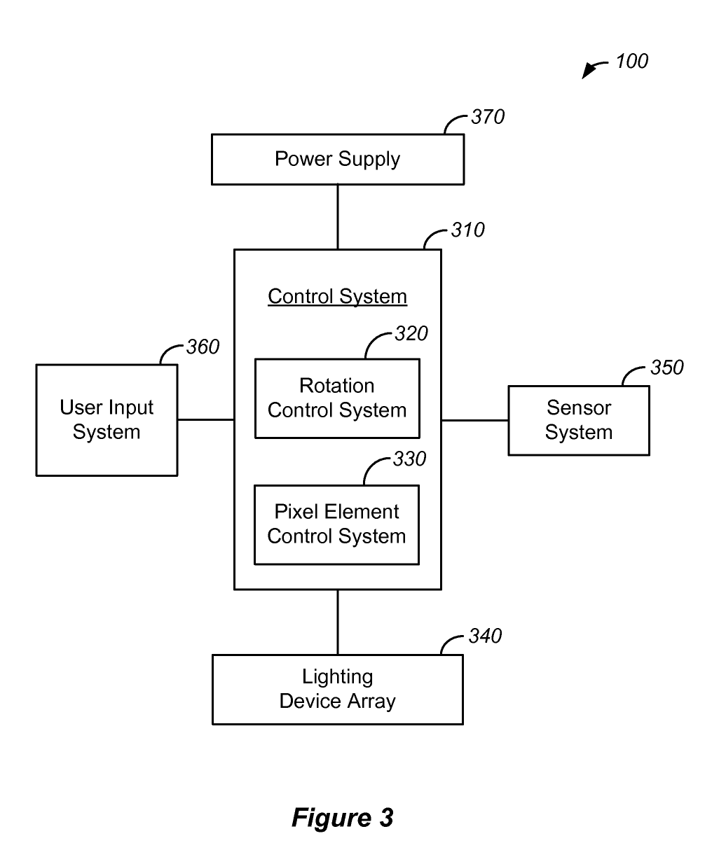

FIG. 3 shows an example of a block diagram indicating components of a persistence-of-vision signage apparatus. In this example, the persistence-of-vision signage apparatus 100 includes a control system 310 for controlling a lighting device array 340. In some implementations, the lighting device array 340 may be substantially similar to the array of lighting devices 105 shown in FIG. 1. In other implementations, the lighting device array 340 may include more or fewer than six of the lighting devices 105. Moreover, the lighting device array 340 may include different arrangements and/or configurations of the lighting devices 105.

The control system 310 may include a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In this example, the control system 310 includes a rotation control system 320 and a pixel element control system 330. The pixel element control system 330 may be configured to control the pixel elements 115 of the lighting devices 105 to produce a desired image on a persistence-of-vision display. The image may be a still image or a video image.

The rotation control system 320 may include one or more motors configured for controlling precisely the positions and rotational speeds of the lighting devices 105. In some such implementations, the motors may be stepper motors. Precise control of the positions and rotational speeds of the lighting devices 105 is desirable for maintaining a desired phase shift between adjacent lighting devices 105, including but not limited to diagonally adjacent lighting devices 105, to avoid blade collisions. Such control is also desirable for maintaining image quality by ensuring that each of the pixel elements 115 is in a desired location when the pixel elements 115 are being controlled by the pixel element control system 330.

The rotation control system 320 may provide a desired level of synchronization of lighting device rotation in various ways. In some implementations, a single motor may be used to drive a group of the lighting devices 105. For example, some or all of the lighting devices 105 may be interconnected by gears, chains, belts or other apparatus that constrains the lighting devices 105 to rotate in a synchronized fashion. In alternate implementations, the rotation control system 320 may provide synchronized commands to a plurality of motors that are used to drive individual lighting devices 105 or groups of the lighting devices 105.

The sensor system 350 may include one or more sensors for monitoring the state of the persistence-of-vision signage apparatus 100. For example, the sensor system 350 may include one or more vibration sensors, heat sensors, etc. The sensor system 350 may include an angle detector, a position detector, etc., configured to detect a position of one or more of the blades 110 of the lighting devices 105.

In some such implementations, the sensor system 350 may include an angle detector configured to determine a position of at least one of the blades 110 of each of the lighting devices 105 in the lighting device array 340. The angle detectors may, for example, include narrow-band optical detectors configured to detect a known range of light wavelengths. At least one of the blades 110 of each of the lighting devices 105 may include a light source that is configured to emit light within the wavelength range. The position of a light source, and therefore the position of a blade 110, may be determined when an optical detector detects light within the wavelength range.

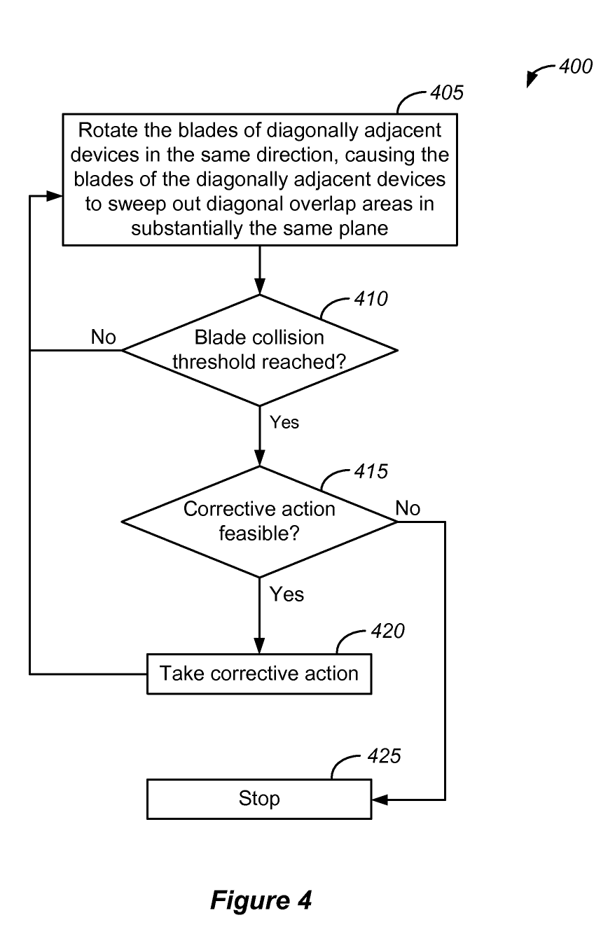

In some implementations, the control system 310 may control the lighting device array 340 based, at least in part, in input from the sensor system 350. Examples of using such input for the rotation control system 320 are described below with reference to FIG. 4.

The pixel element control system 330 also may be configured to receive current position and/or angle information from an angle detector of the sensor system 350. The pixel element control system 330 may use such data to determine control data for the pixel elements 115. For example, in some implementations the pixel element control system 330 may reference a lookup table that indicates that a pixel element 115 should be activated or deactivated when the pixel element 115 is in a particular position. In some implementations (such as for producing a video image), the pixel element control system 330 may be configured to control a particular pixel element 115 that is in a particular location differently at different times.

In some implementations, the pixel element control system 330 may not rely on position and/or angle information from the sensor system 350 for normal operation. In some such implementations, the position of the blades 110 at a given time may be determined according to input from the rotation control system. Alternatively, the position of the blades 110 at a given time may be determined based on a known angular velocity and a known initial position at a given time.

In some such implementations, the control system 310 may periodically measure positions of the blades 110 and recalibrate the operations of the pixel element control system 330 and/or the rotation control system 320. In some such implementations, data from an angle detector of the sensor system 350 may be used periodically to provide adjustments as needed. For example, if a phase shift angle has drifted, the pixel element control system 330 may apply a time adjustment to an output stream of control data for the pixel elements 115. In some embodiments, if the angular speed of one or more of the lighting devices 105 in the lighting device array 340 has drifted, the rotation control system 320 may make adjustments to the operation of one or more motors that are used to rotate lighting devices 105.

FIG. 4 shows an example of a flow diagram that outlines a process of operating a persistence-of-vision signage apparatus. The process 400 begins with block 405, which corresponds with a state of normal operation of a persistence-of-vision signage apparatus 100 such as that depicted in FIG. 1. In this example, block 405 specifically involves a process wherein the blades 110 of diagonally adjacent lighting devices 105 are rotated in the same direction. Here, this process causes the blades 110 of the diagonally adjacent lighting devices 105 to sweep out diagonal overlap areas 135 in substantially the same plane. Block 405 may be performed, at least in part, by a rotation control system 320 such as that described above with reference to FIG. 3. However, block 405 may also involve the pixel element control system 330 controlling the pixel elements 115 to produce a persistence-of-vision display.

In block 410, the control system 310 determines whether the operation of persistence-of-vision signage apparatus 100 needs to be changed. In this example, the control system 310 determines whether a blade collision threshold has been reached. For example, the control system 310 may determine whether the blades 110 of the diagonally adjacent lighting devices 105 are rotating out of phase by an acceptable phase difference. In one such example, the control system 310 may determine, based on data from an angle detector of the sensor system 350 whether the blades 110 of the diagonally adjacent lighting devices 105 are rotating within a predetermined range of acceptable phase difference angles, e.g., between 11 degrees and 15 degrees out of phase.

If the control system 310 determines that a blade collision threshold has not been reached, normal operation continues in block 405. However, if the control system 310 determines that a blade collision threshold has been reached, the control system 310 determines whether corrective action is feasible (block 415). If so, corrective action is taken (block 420) and then normal operation is resumed (block 405). For example, the rotation control system 320 may make adjustments to the operation of one or more motors that are used to rotate lighting devices 105 in order to bring the phase difference angle of the diagonally adjacent lighting devices 105 within the predetermined range of acceptable phase difference angles.

The control system 310 may evaluate various factors in block 415 to determine whether corrective action is feasible. For example, the control system 310 may evaluate vibration data, temperature data, acceleration data or other data from the sensor system 350 to determine whether the persistence-of-vision signage apparatus 100 can continue to be operated safely and/or within acceptable operation parameters. For example, excessive vibration may indicate that one or more blades 110, lighting devices 105 and/or other components of the lighting device array 340 are coming loose, that a bearing, a gear or other device is damaged, etc. If the control system 310 determines in block 415 that the persistence-of-vision signage apparatus 100 cannot continue to be operated safely and/or within acceptable operation parameters, the control system 310 may shut down the persistence-of-vision signage apparatus 100 (block 425).

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus including an array of devices having blades configured for rotation, the apparatus comprising:
at least two rows of the devices; and
at least two columns of the devices, wherein the blades of diagonally adjacent devices offset by one row and one column are configured to:
rotate in the same direction and in substantially the same plane;
sweep out diagonal overlap areas; and
rotate out of phase.

2. The apparatus of claim 1, wherein each of the devices includes four blades.

3. The apparatus of claim 1, wherein the blades of a first device in each row are configured to rotate in a first direction and sweep out a first area and the blades of an adjacent second device in the row are configured to rotate in a second direction opposite the first direction and sweep out a second area in substantially the same plane that overlaps the first area.

4. The apparatus of claim 3, wherein the blades of the first device and the blades of the second device are out of phase by approximately 40 degrees to 50 degrees.

5. The apparatus of claim 3, wherein the first area overlaps with the second area by more than half of a blade radius.

6. The apparatus of claim 1, wherein the blades of a first device in each column are configured to rotate in a first direction and sweep out a first area and the blades of an adjacent second device in the column are configured to rotate in a second direction opposite the first direction and sweep out a second area in substantially the same plane that overlaps the first area.

7. The apparatus of claim 6, wherein the blades of the first device and the blades of the second device are out of phase by approximately 40 degrees to 50 degrees.

8. The apparatus of claim 6, wherein the first area overlaps with the second area by more than half of a blade radius.

9. The apparatus of claim 1, wherein the blades of diagonally adjacent devices rotate out of phase by between 10 degrees and 20 degrees.

10. The apparatus of claim 1, wherein the blades of diagonally adjacent devices rotate out of phase by an angle in the range of approximately plus or minus 25 degrees.

11. The apparatus of claim 1, wherein the blades of a first device in a row and the blades of a third device in a row rotate in phase and in the same direction.

12. The apparatus of claim 1, further including a rotation control system configured for rotating the blades.

13. The apparatus of claim 1, further including a plurality of pixel elements disposed on each blade.

14. The apparatus of claim 13, wherein the diagonal overlap areas have a width that is at least as large as a width of a pixel element.

15. The apparatus of claim 13, wherein the diagonal overlap areas have a width that is less than a width of a pixel element.

16. The apparatus of claim 13, wherein the pixel elements include light-emitting diodes.

17. The apparatus of claim 13, further including a pixel element control system configured for controlling the pixel elements.

18. The apparatus of claim 17, wherein the pixel element control system is configured to control the pixel elements to produce an image of a display.

19. The apparatus of claim 18, wherein the display is a persistence-of-vision display.

20. The apparatus of claim 18, wherein the image is a video image.

21. The apparatus of claim 1, wherein a first axis of rotation of a first device in a row is offset by a second axis of rotation of a second device in the row by less than 1.5 times a radius of a blade.

22. The apparatus of claim 1, wherein a first axis of rotation of a first device in a column is offset by a second axis of rotation of a second device in the column by less than 1.5 times a radius of a blade.

23. An apparatus including an array of devices having blades configured for rotation, the apparatus comprising:
at least two rows of the devices;
at least two columns of the devices, wherein the blades of diagonally adjacent devices offset by one row and one column; and
means for rotating the blades of diagonally adjacent devices in the same direction to sweep out diagonal overlap areas in substantially the same plane without causing a blade collision.

24. The apparatus of claim 23, wherein each of the devices includes four blades.

25. The apparatus of claim 23, wherein the rotating means includes means for rotating the blades of diagonally adjacent devices out of phase.

26. The apparatus of claim 25, wherein the rotating means includes means for rotating the blades of diagonally adjacent devices out of phase by between 10 degrees and 20 degrees.

27. The apparatus of claim 25, wherein the rotating means includes means for rotating the blades of diagonally adjacent devices out of phase by an angle in the range of approximately plus or minus 25 degrees.

28. The apparatus of claim 23, wherein the rotating means comprises:
means for rotating the blades of a first device in the row in a first direction to sweep out a first area; and
means for rotating the blades of an adjacent second device in the row in a second direction opposite the first direction to sweep out a second area that overlaps the first area and is in substantially the same plane as the first area.

29. The apparatus of claim 28, wherein the rotating means includes means for rotating the blades of the first device out of phase with the blades of the second device by approximately 40 degrees to 50 degrees.

30. The apparatus of claim 28, wherein the first area overlaps with the second area by more than half of a blade radius.

31. The apparatus of claim 23, wherein the rotating means comprises:
means for rotating the blades of a first device in the column in a first direction to sweep out a first area; and
means for rotating the blades of an adjacent second device in the column in a second direction opposite the third direction to sweep out a second area that overlaps the first area and is in substantially the same plane as the first area.

32. The apparatus of claim 31, wherein the rotating means includes means for rotating the blades of the first device out of phase with the blades of the second device by approximately 40 degrees to 50 degrees.

33. The apparatus of claim 31, wherein the first area overlaps with the second area by more than half of a blade radius.

34. A method of operating rows and columns of devices having blades configured for rotation, the method comprising:
rotating the blades of diagonally adjacent devices in the same direction, the diagonally adjacent devices being offset by one row and one column; and
causing the blades of the diagonally adjacent devices to sweep out diagonal overlap areas in substantially the same plane without causing a blade collision.

35. The method of claim 34, wherein the rotating involves rotating the blades of diagonally adjacent devices out of phase.

36. The method of claim 35, wherein the rotating involves rotating the blades of diagonally adjacent devices out of phase by between 10 degrees and 20 degrees.

37. The method of claim 35, wherein the rotating involves rotating the blades of diagonally adjacent devices out of phase by an angle in the range of approximately plus or minus 25 degrees.

38. The method of claim 35, further including determining whether a blade collision threshold has been reached.

39. The method of claim 38, wherein it is determined that a blade collision threshold has been reached, further including taking corrective action.

40. The method of claim 39, wherein the corrective action involves bringing a phase difference angle of the diagonally adjacent devices within a range of acceptable phase difference angles.

41. An apparatus, comprising:
an array of devices having blades configured for rotation, the array including at least two rows and two columns of the devices, each device including a plurality of pixel elements disposed on each blade with a pitch P, each blade having at least one edge pixel element disposed at a maximum distance from an axis of rotation of the blade; and
a rotation control system configured to:
rotate the blades of diagonally adjacent devices offset by one row and one column in the same direction and in substantially the same plane; and
produce a spacing S between edge subpixels disposed on the blades of diagonally adjacent devices when the diagonally adjacent blades are aligned, wherein S is less than or substantially equal to P.

42. The apparatus of claim 41, wherein the blades of diagonally adjacent devices do not sweep out diagonal overlap areas.

43. The apparatus of claim 41, wherein each of the devices includes four blades.

44. The apparatus of claim 41, further including a pixel element control system configured for controlling the pixel elements to produce an image of a persistence-of-vision display.
